(19) United States
(12) Patent Application Publication
(10) Pub. No.: US 2005/0279633 A1
(43) Pub. Date: Dec. 22, 2005

(54) Cationic electrodeposition coating composition

(76) Inventors: Teruzo Toi, Osaka-fu (JP); Naotaka Kitamura, Osaka-fu (JP); Mitsuo Yamada, Osaka-fu (JP)

Correspondence Address: WENDEROTH, LIND & PONACK, L.L.P., 2033 K STREET N. W., SUITE 800, WASHINGTON, DC, 20006-1021, US

(21) Appl. No.: 11/153,546

(22) Filed: Jun. 16, 2005

(30) Foreign Application Priority Data
Jun. 16, 2004 (JP) 2004-178284

(51) Int. Cl. B01D 57/02; C08J 5/12

(52) U.S. Cl. 204/502; 204/505; 106/287.3

(57) ABSTRACT

The present invention relates to a cationic electrodeposition coating composition which hardly shows poor appearance on a coating film and has high throwing power. The present invention provides a cationic electrodeposition coating composition comprising a binder resin composed of an amine-modified bisphenol epoxy resin and a blocked isocyanate curing agent in emulsification state, wherein the emulsification of the binder resin is conducted by either an amine-modified bisphenol epoxy resin having a quaternary ammonium group or an emulsifying resin having a quaternary ammonium group as an additional component other than the binder resin.

### FIELD OF THE INVENTION

The present invention relates to a cationic electrodeposition coating composition which hardly shows poor appearance on a coating film and has high throwing power. The present invention also relates to a process for forming an electrodeposition coating film using the cationic electrodeposition coating composition.

### BACKGROUND OF THE INVENTION

A cationic electrodeposition coating method can be widely employed for undercoating an article having large surface area and complex shape, and as an automobile body, because it provides the article with coatings in detailed portions even if it has a complicated shape. The cationic electrodeposition coating method is carried out by immersing an object to be coated into a cationic electrodeposition coating composition as a cathode, and applying a voltage thereto.

Deposition of a coating film in the process of cationic electrodeposition coating is caused by electrochemical reaction, and the coating film is deposited on a surface of the object to be coated by application of voltage. Since the deposited coating film has a dielectric property, the electric resistance of the coating film will increase as the deposited layer increases in thickness by progression of the deposition of the coating film during the coating process. As the result, deposition of the coating composition onto the film-deposited sites decreases, while deposition of the coating film onto non-deposited sites starts. In this manner, the solid components of the coating composition are successively deposited to the object, thereby completing the coating. In the present specification, the property by which the coating film is successively formed onto non-coated sites of the object to be coated is referred to as “throwing power”.

To heighten merely an electric resistance of the cationic electrodeposition coating film so as to improve the throwing power induces an uprise of applied voltage. It may also cause generation of gas-pinhole due to hydrogen gas generated by electrocoating and poor appearance of the cationic electrodeposition coating film, and they are not preferable.

In recent years, electrodeposition coating is often carried out on galvanized steel panels of which a surface has been plated with zinc. The galvanized steel panels are excellent in rust-preventing property as compared with conventional steel plates, so that the galvanized steel panels can achieve an enhanced rust-preventing property if they are used as an object to be coated. On the other hand, if galvanized steel panels are used as an object to be coated, gas-pinholes or craters are liable to be generated in the obtained electrodeposition coating film, thereby a problem in poor appearance is likely to be generated. This seems to result from facilitated generation of spark discharge in hydrogen gas. The discharge voltage of hydrogen gas generated on the object to be coated side in cationic electrodeposition coating is lower in the galvanized steel panels than in iron steel plates. Consequently, the electrodeposition coating composition which can be deposited by application of lower voltage is useful, in particular the electrodeposition coating of galvanized steel panels.

In addition, the forming of a thicker electrodeposition coating film may be required in for example design use. However, to heighten the application of voltage in electrodeposition coating so as to obtain the thicker electrodeposition coating film may increase generation of gas-pinhole.

The present applicant proposes a lead-free cationic electrodeposition coating composition in Japanese Patent Kokai Publication No. 2002-356647. The publication suggests a lead-free cationic electrodeposition coating composition with high throwing power. There is further demand regarding high throwing power, which requires another study of components constituting.

### OBJECTS OF THE INVENTION

The present invention is to find solutions to problems described above. A main object of the present invention is to provide a cationic electrodeposition coating composition with high throwing power, which shows excellent appearance of a coated object.

### SUMMARY OF THE INVENTION

The present invention provides a cationic electrodeposition coating composition comprising a binder resin composed of an amine-modified bisphenol epoxy resin and a blocked isocyanate curing agent in emulsification state, wherein
the emulsification of the binder resin is conducted by either an amine-modified bisphenol epoxy resin having a quaternary ammonium group or an emulsifying resin having a quaternary ammonium group as an additional component other than the binder resin, thereby accomplishing the object described above.

One embodiment of the cationic electrodeposition coating composition comprises a binder resin emulsion (A-1) which comprises:
a binder resin composed of (a-1) an amine-modified bisphenol epoxy resin having an amino group and (b) a blocked isocyanate curing agent, and
(c) an emulsifying resin being a modified epoxy resin having a quaternary ammonium group.

Another one embodiment of the cationic electrodeposition coating composition comprises a binder resin emulsion (A-2) composed of:
(a-2) an amine-modified bisphenol epoxy resin having an amino group and a quaternary ammonium group, and
(b) a blocked isocyanate curing agent.

A ratio of an equivalent number of quaternary ammonium group to an equivalent number of neutralizable amino group in the binder resin emulsion may preferably be within a range of from 1.0:1.0 to 1.0:4.0.

It is also preferred that a solid content ratio by weight of (a-1) amine-modified bisphenol epoxy resin having an amino group to (c), emulsifying resin comprising a modified epoxy resin having a quaternary ammonium group in the binder resin emulsion (A-1) may preferably be within a range of from 98:2 to 70:30.

It is also preferred that a cationic electrodeposition coating composition further contains (d) anime-modified novolak epoxy resin in the range of from 0.1 to 5.0 parts by weight based on 100 parts by weight of a solid content of the binder resin.

Electric conductivity of the cationic electrodeposition coating composition may preferably be within a range of from 1200 to 1500 μS/cm.

A coating film obtained from the cationic electrodeposition coating composition preferably has a membrane resistance of 1000 to 1600 kΩ/cm² at a thickness of 20 μm.

The present invention also provides a process for forming an electrodeposition coating film with prevention of generation of gas-pinhole comprising the step of immersing an object to be coated in the cationic electrodeposition coating composition to electrocoat.

The present invention also provides a process for forming an electrodeposition coating film with a film thickness of not less than 15 μm comprising the step of immersing a galvanized steel panel in the cationic electrodeposition coating composition to electrocoat.

The present invention also provides a process for preventing generation of gas-pinhole. In the process for forming a coating film by cationically-electrocoating a cationic electrodeposition coating composition, the process for preventing generation of gas pinhole of the coating film characterized in that the electrodeposition coating composition comprises a binder resin emulsion having a quaternary ammonium group.

The term “amine-modified bisphenol epoxy resin” represents a resin obtained by allowing a bisphenol epoxy resin to react with amine whereby epoxy group thereof undergoes-ring-opening and, at the same time, an amino group is introduced.

The term “amine-modified novolak epoxy resin” represents a resin obtained by allowing a novolak epoxy resin to react with amine whereby epoxy group thereof undergoes ring-opening and, at the same time, an amino group is introduced.

The cationic electrodeposition coating composition of the present invention has high throwing power and repressed occurrence of poor appearance of the coated object. The cationic electrodeposition coating composition of the present invention sufficiently represses generation of poor appearance in case of electrocoating galvanized steel panels which is likely to generate gas-pinholes. The cationic electrodeposition coating composition of the present invention has excellent property of preventing generation of gas-pinhole (hereinafter, referred to as “gas-pinhole property”), and can conduct deposition of coating by application of lower voltage. Accordingly, the cationic electrodeposition coating composition of the present invention can provide a thicker electrodeposition coating film.

### BRIEF DESCRIPTION OF THE DRAWINGS

FIG. 1 is a perspective view illustrating one example of a box used for evaluating throwing power.

FIG. 2 is a cross-sectional view illustrating a method of evaluating throwing power.

### DETAILED DESCRIPTION OF THE PREFERRED EMBODIMENTS

The cationic electrodeposition coating composition used in the present invention contains an aqueous solvent; binder resin emulsion dispersed or dissolved in the aqueous solvent; acid for neutralization; and an organic solvent. The cationic electrodeposition coating composition may further contain a pigment. A binder resin in the binder resin emulsion is a resin component consisting of amine-modified bisphenol epoxy resin and blocked isocyanate curing agent. The term “(a) amine-modified bisphenol epoxy resin” as used herein includes either amine-modified bisphenol epoxy resin having a quaternary ammonium group or amine-modified bisphenol epoxy resin having no quaternary ammonium group. The epoxy resin (a) can be (a-1) amine-modified bisphenol epoxy resin having an amino group and (a-2) amine-modified bisphenol epoxy resin having an amino group and a quaternary ammonium group.

In one embodiment of the cationic electrodeposition coating composition according to the present invention include the cationic electrodeposition coating composition containing a binder resin emulsion (A-1), wherein the binder resin emulsion (A-1) contains:
a binder resin, and
(c) emulsifying resin comprising a modified epoxy resin having a quaternary ammonium group,
   wherein the binder resin comprises (a-1) amine-modified bisphenol epoxy resin having an amino group and (b) blocked isocyanate curing agent.

In one another embodiment of the cationic electrodeposition coating composition according to the present invention include a cationic electrodeposition coating composition containing a binder resin emulsion (A-2), wherein the binder resin emulsion (A-2) contains a binder resin comprising:
(a-2) amine-modified bisphenol epoxy resin having an amino group and a quaternary ammonium group, and
(b) blocked isocyanate curing agent.
   (a) Amine-Modified Bisphenol Epoxy Resin

The (a) amine-modified bisphenol epoxy resin used in the present invention includes an amine-modified bisphenol epoxy resin. The amine-modified bisphenol epoxy resins may be well known resins described in Japanese Patent Kokai Publication Nos. sho 54(1979)-4978, sho 56(1981)-34186 and the like. The resin (a) is typically made by opening all epoxy rings of a bisphenol epoxy resin with an amine compound; or by opening a part of the epoxy rings with the other activated hydrogen compound and opening the residual epoxy rings with an amine compound.

Examples of the bisphenol epoxy resins include bisphenol A type epoxy resins and bisphenol F type epoxy resins. Examples of the bisphenol A type epoxy resins, which are commercially available from Yuka Shell Epoxy Co., Ltd., include Epikote 828 (epoxy equivalent value: 180 to 190), Epikote 1001 (epoxy equivalent value: 450 to 500), Epikote 1010 (epoxy equivalent value: 3000 to 4000) and the like. Examples of the bisphenol F type epoxy resins, which are commercially available from Yuka Shell Epoxy Co., Ltd., include Epikote 807 (epoxy equivalent value: 170) and the like.

Oxazolidone ring containing epoxy resin having the following formula; 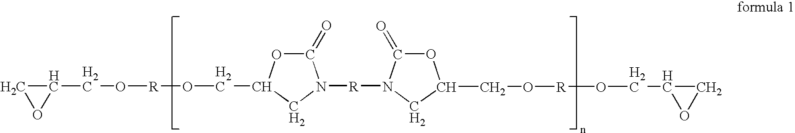
wherein, R represents a residual group obtained by removing glycydyl group from diglycidyl epoxy compound, R′ represents a residual group obtained by removing isocyanate group from diisocyanate compound, and n represents a positive integer;
   may be used as the (a) amine-modified epoxy resin. The oxazolidone ring containing epoxy resin can provide the cationic electrodeposition coating composition which can make a coating film having excellent heat resistance and corrosion resistance. The epoxy resin is disclosed in Japanese Patent Kokai Publication No. Hei 5(1993)-306327. Japanese Patent Kokai Publication No. Hei 5(1993)-306327 is a priority patent application of U.S. Pat. No. 5,276,072, which is herein incorporated by reference.

A method of introducing the oxazolidone ring into the epoxy resin includes a method comprising the steps of heating the blocked isocyanate curing agent blocked with lower alcohol such as methanol and polyepoxide under basic catalyst and keeping its heating temperature constant, and distilling off the by-product lower alcohol from the system.

The particularly preferred epoxy resin is an oxazolidone ring containing resin. Using the oxazolidone ring containing resin can provide the coating film which is superior in heat resistance, corrosion resistance and impact resistance.

It is well known that the epoxy resin containing oxazolidone ring can be obtained by reaction of bifunctional epoxy resin with diisocyanate blocked with monoalcohol (that is, bisurethane). The specific examples of the oxazolidone ring containing epoxy resin and the preparing method thereof are disclosed in paragraphs [0012] to [0047] of Japanese Patent Kokai Publication No. 2000-128959, which are well known. Japanese Patent Kokai Publication No. 2000-128959 is a priority patent application of U.S. Pat. No. 6,664,345, which is herein incorporated by reference.

The epoxy resin may be modified with suitable resins, such as polyesterpolyol, polyetherpolyol, and monofuctional alkylphenol. In addition, the epoxy resin can be chain-extended by the reaction of epoxy group with diol or dicarboxylic acid.

It is desired for the epoxy resin to be ring-opened with activated hydrogen compound such that they have an amine equivalent value of 0.3 to 4.0 meq/g after ring opening, and particularly 5 to 50% thereof is primary amino group.

A typical example of the activated hydrogen compounds, into which a cationic group can be introduced, includes primary amine, secondary amine or the like. A reaction of the epoxy resin with a secondary amine provides an amine-modified bisphenol epoxy resin having tertiary amino group. A reaction of the epoxy resin with a primary amine provides an amine-modified bisphenol epoxy resin having secondary amino group. A reaction of the epoxy resin with a resin having primary amino group and secondary amino group provides an amine-modified bisphenol epoxy resin having primary amino group. In case of using a resin having primary amino group and secondary amino group, the amine-modified epoxy resin can be prepared by the method including the following steps;
blocking primary amino group of the resin having primary amino group and secondary amino group with a ketone to produce a ketimine before reacting with the epoxy resin,
introducing the ketimine into the epoxy resin, and
deblocking the ketone to produce the amine-modified bisphenol epoxy resin having primary amino group.

The specific example of the primary amine, the secondary amine and the ketimine includes butylamine, octylamine, diethylamine, dibutylamine, methylbutylamine, monoethanolamine, diethanolamine, N-methylethanolamine, as well as secondary amines obtained by blocking primary amines, such as ketimine of aminoethylethanolamine, diketimine of diethylenetriamine. The amines may be used in combination.

An amine-modified bisphenol epoxy resin (a-1) having an amino group may be prepared by using the primary amine and/or the secondary amine as described above. The amino group which the resin (a-1) may have includes primary amino group, secondary amino group and tertiary amino group, and the resin (a-1) has one or more the amino groups.

An amine-modified bisphenol epoxy resin (a-2) having an amino group and a quaternary ammonium group may be prepared by using one or more kinds selected from the group consisting of a primary amine, a secondary amine and a ketimine, which may be called “amines” hereinafter, and using a tertiary amine together with the amines. The amines and the tertiary amine react with epoxy group in the bisphenol epoxy resin to obtain the amine-modified bisphenol epoxy resin (a-2) having an amino group and a quaternary ammonium group. Quaternary ammonium functional group can be obtained by reacting epoxy group with the tertiary amine. An example of amino group in the resin (a-2) includes primary amino group, secondary amino group and tertiary amino group, and the resin (a-2) has one or more the amino groups.

A typical example of tertiary amino group include dimethylethanolamine, trimethylamine, triethylamine, dimethylbenzylamine, diethylbenzylamine, N,N-dimethyl cyclohexylamine, tri-n-buthylamine, diphenethylmethylamine, dimethylaniline, N-methylmorpholine or the like.

(c) Emulsifying Resin Comprising a Modified Epoxy Resin Having a Quaternary Ammonium Group

The emulsifying resin (c) comprising a modified epoxy resin having a quaternary ammonium group is a resin which assists emulsification of the binder resin. The resin herein includes (a) amine-modified bisphenol epoxy resin and (b) blocked isocyanate curing agent.

When the amine-modified bisphenol epoxy resin (a-2) having an amino group and a quaternary ammonium group is used in the present invention as (a) amine-modified bisphenol epoxy resin, the emulsifying resin (c) may not be used, because the resin (a-2) has a quaternary ammonium group and has self-emulsifying effect.

The emulsifying resin (c) is not always used when the resin (a-2) is used in the present invention, but, the present invention is not intended to eliminate an embodiment of a cationic electrodeposition coating composition containing a binder resin emulsion, wherein the the binder resin emulsion contains:
a binder resin, and
(c) emulsifying resin comprising a modified epoxy resin having a quaternary ammonium group,
   wherein the binder resin comprises (a-2) amine-modified bisphenol epoxy resin having an amino group and a quaternary ammonium group and (b) blocked isocyanate curing agent.

The modified epoxy resin having a quaternary ammonium group is a resin which may be obtained by reacting an epoxy resin with the tertiary amine.

A typical example of the epoxy resin may be polyepoxide. The polyepoxide preferably has an average of two or more 1,2-epoxy groups per molecule. The polyepoxide preferably has an epoxy equivalent of 180 to 1000, especially of 375 to 800. When the epoxy equivalent is less than 180, electrodeposition may not form film and a coating film may not be obtained. When the epoxy equivalent is more than 1000, the resin may have insufficient water solubility because of lack of an amount of a quaternary ammonium group per molecule.

A typical example of the modified epoxy resin includes the bisphenol epoxy resin as described above. The oxazolidone ring containing epoxy resin may be used as the epoxy resin.

When the epoxy resin has a hydroxyl group, a half blocked isocyanate may be reacted with the hydroxyl group of the resin to form an urethane-modified epoxy resin having a blocked isocyanate group.

The half blocked isocyanate used for the reaction of the epoxy resin can be prepared by partially blocking an organic polyisocyanate with a blocking agent. The reaction of the organic polyisocyanate with the blocking agent may preferably be conducted by adding the blocking agent dropwise to the organic polyisocyanate under the condition of cooling to a temperature of 40 to 50° C. with stirring, optionally in the presence of tin catalyst.

The polyisocyanate can be anyone as long as it has an average of two or more isocyanate groups. A typical example of the polyisocyanate includes a polyisocyanate which may be used for preparing the blocked isocyanate curing agent as described below.

Suitable blocking agent for preparing the half blocked isocyanate includes lower aliphatic alkyl monoalcohol having 4 to 20 carbon atoms. A typical example of the blocking agent includes butyl alcohol, amyl alcohol, hexyl alcohol, 2-ethylhexyl alcohol, heptyl alcohol or the like.

The reaction of the epoxy resin with the half blocked isocyanate may preferably be conducted at a temperature of 140° C. and keeping the temperature at least one hour.

The tertiary amine using for the preparation of the modified epoxy resin having a quaternary ammonium group may preferably be have 1 to 6 carbon atoms and a hydroxyl group. A typical example of the tertiary amine includes dimethylethanolamine, trimethylamine, triethylamine, dimethylbenzylamine, diethylbenzylamine, N,N-dimethyl cyclohexylamine, tri-n-buthylamine, diphenethylmethylamine, dimethylaniline, N-methylmorpholine or the like as tertiary amine as explained above.

A neutralizing acid used by mixing with the tertiary amine is not limited, but includes inorganic acids or organic acids, such as hydrochloric acid, nitric acid, phosphoric acid, formic acid, acetic acid, lactic acid or the like. The resulting salt of the tertiary amine with the neutralizing acid may be reacted with the epoxy resin in a conventional method. An embodiment of a method of preparing the emulsifying resin includes the step of;
dissolving the epoxy resin in an organic solvent such as ethyleneglycol monobuthylether,
heating the resulting solution at a temperature of 60 to 100° C., and
adding dropwise the salt of the tertiary amine to the reaction mixture and keeping the reaction mixture at a temperature of 60 to 100° C. until the reaction mixture has an acid number of 1.
   (b) Blocked Isocyanate Curing Agent

Polyisocyanate used as the blocked isocyanate curing agent of the present invention is a compound having at least two isocyanate groups in one molecular. The polyisocyanates may be anyone of aliphatic type, cycloaliphatic type, aromatic type or aromatic-aliphatic type.

Examples of the polyisocyanates include aromatic diisocyanates, such as tolylene diisocyanate (TDI), diphenylmethane diisocyanate (MDI), p-phenylene diisocyanate and naphthalene diisocyanate; aliphatic diisocyanates having 3 to 12 carbon atoms, such as hexamethylene diisocyanate (HDI), 2,2,4-trimethylhexane diisocyanate and lysine diisocyanate; cycloaliphatic diisocyanates having 5 to 18 carbon atoms, such as 1,4-cyclohexane diisocyanate(CDI), isophorone diisocyanate (IPDI), 4,4′-dicyclohexylmethane diusocyanate (hydrogenated MDI), methylcyclohexane diusocyanate, isopropylidenedicyclohexyl-4,4′-diisocyanate and 1,3-diisocyanatomethylcyclohexane (hydrogenated XDI), hydrogenated TDI, 2,5- or 2,6-bis(isocyanate methyl)-bicyclo[2.2.1]heptane (referred to as norbornane diisocyanate); aliphatic diisocyanates having aromatic ring, such as xylylene diisocyanate (XDI) and tetramethylxylylene diisocyanate (TMXDI); modified compounds thereof (such as urethane compound, carbodiimide, urethodion, urethonimine, biuret and/or isocyanurate modified compound); and the like. The polyisocyanate may be used alone or in combination of two or more.

Adducts or prepolymers obtained by reacting the polyisocyanate with polyalcohols such as ethylene glycol, propylene glycol, trimethylolpropane and hexanetriol at a NCO/OH ratio of not less than 2 may also be used as the blocked isocyanate curing agent.

The block agent is a compound which can adduct to polyisocyanate group to be stable at room temperature, but reproduce a free isocyanate group by heating to a temperature more than a dissociation temperature.

The blocking agent can be α-caprolactam and ethylene glycol monobutyl ether (butyl cellosolve) that are usually used.

(d) Amine-Modified Novolak Epoxy Resin

The amine-modified novolak epoxy resin (d) optionally used in the present invention may typically be produced by allowing an epoxy ring of a novolak epoxy resin to undergo ring-opening with an amine. An epoxy resin represented by the following formula: 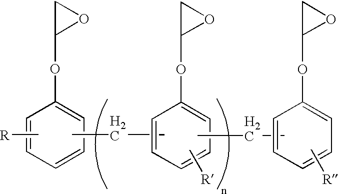
wherein R, R′, and R″ are each independently hydrogen or a linear or branched alkylene group having 1 to 5 carbon atoms, and the repetition unit number n is 0 to 25:
   can used as the novolak epoxy resin.

A typical example of the novolak epoxy resin is a phenol novolak resin or a cresol novolak resin. The former is commercially available as YDPN-638 (manufactured by Toto Kasei Co., Ltd.) and the latter is also commercially available as YDCN-701 (the same), YDCN-704 (the same), and the like.

The amines to be allowed to react with the epoxy group in the novolak epoxy resin include primary amines and secondary amines. Among them, secondary amines are especially preferable. The reaction of the epoxy resin with the secondary amines produces an amine-modified epoxy resin having a tertiary amino group.

Specific examples of amines include butylamine, octylamine, diethylamine, dibutylamine, methylbutylamine, monoethanolamine, diethanolamine, N-methyl ethanolamine, and secondary amines obtained by blocking primary amines such as ketimine of aminoethyl ethanolamine and diketimine of diethylenetriamine. Two or more kinds of amines may be used in combination. A reaction of an epoxy resin and amines are disclosed in Japanese Patent Kokai Publication Nos. Hei 5(1993)-306327 and 2000-128959. Japanese Patent Kokai Publication No. Hei 5(1993)-306327 is a priority patent application of U.S. Pat. No. 5,276,072, which is herein incorporated by reference. Japanese Patent Kokai Publication No. 2000-128959 is a priority patent application of U.S. Pat. No. 6,664,345, which is herein incorporated by reference.

In addition, if the epoxy resin remains plural epoxy groups, the epoxy groups might be partially reacted with carboxylic acids such as acetic acid, alcohols such as allyl alcohol, or phenols such as nonylphenol.

The amount of the amine-modified novolak epoxy resin (d) may preferably be from 0.1 parts by weight to 5.0 parts by weight based on 100 parts by weight of a solid content of the binder resin in the cationic electrodeposition coating composition. The lower limit of the amount of the amine-modified novolak epoxy resin (d) may be more preferably 0.5 parts by weight, most preferably 1.0 parts by weight. The upper limit of the amount of the amine-modified novolak epoxy resin (d) may be more preferably 4.5 parts by weight, most preferably 4.0 parts by weight. The use of the novolak epoxy resin (d) within the above range can reduce possibility of generating gas-pinhole or craters, and can further improve coating suitability to galvanized steel panels of the resulting cationic electrodeposition coating composition. In addition, the resulting cationic electrodeposition coating composition has high throwing power even if it is electrocoated in a short period of time.

The amine-modified novolak epoxy resin may be used in the form of a salt which is obtained by neutralizing with a neutralizing acid. Any neutralizing acid can be used to neutralize the amine-modified novolak epoxy resin. An amount of the neutralizing acid is not less than a minimum amount that the neutralizing acid can make the amine-modified novolak epoxy resin dispersed in the aqueous medium. The amount of the neutralizing acid may vary depending on kinds of the amine or the neutralized salt. The amine-modified novolak epoxy resin has an effect of adjusting an electric conductivity of the cationic electrodeposition coating composition within an optimal range of making throwing power high and coating suitability for galvanized steel panels excellent.

Pigment

The cationic electrodeposition coating composition used in the process of the present invention may contain pigment, which has been conventionally used for a coating. Examples of the pigments include inorganic pigments, for example, a coloring pigment, such as titanium dioxide, carbon black and colcothar; an extender pigment, such as kaolin, talc, aluminum silicate, calcium carbonate, mica and clay; a rust preventive pigment, such as zinc phosphorate, iron phosphorate, aluminum phosphorate, calcium phosphorate, zinc phosphite, zinc cyanide, zinc oxide, aluminum tripolyphosphorate, zinc molybdate, aluminum molybdate, calcium molybdate, aluminum phosphomolybdate and aluminum zinc phosphomolybdate.

When the pigment is used as a component of the electrodeposition coating composition, a content of the pigment may preferably be not more than 30% by weight based on the solid components of the coating composition. The content of the pigment is more preferably within the range of 1 to 25% by weight. If the content of the pigment is more than 30% by weight, it may induce poor horizontal appearance of the resulting cationic electrodeposition coating film because of sedimentation of the pigment.

When the pigment is used as a component of the electrodeposition coating composition, the pigment is generally pre-dispersed in an aqueous solvent at high concentration in the form of a paste (pigment dispersed paste). It is difficult to uniformly disperse the pigment at low concentration in one step because of powdery form of the pigment. The paste is generally called pigment dispersed paste.

The pigment dispersed paste is prepared by dispersing the pigment together with pigment dispersing resin varnish in an aqueous medium. As the pigment dispersing resin, cationic or non-ionic low molecular weight surfactant, or cationic polymer such as modified epoxy resin having a quaternary ammonium group and/or tertiary sulfonium group can be used. As the aqueous medium, deionized water or water containing a small amount of alcohol can be used.

The pigment dispersing resin is generally used at the solid content of 20 to 100 parts by weight based on 100 parts by weight of the coating composition. The pigment dispersed paste can be obtained by mixing the pigment dispersing resin varnish with the pigment, and dispersing the pigment using a suitable dispersing apparatus, such as a ball mill or sand grind mill.

The cationic electrodeposition coating composition may optionally contains a catalyst. Specific example of the catalyst includes for example organic tin compounds such as dibutyltin dilaurate, dibutyltin oxide, dioctyltin oxide; amines such as N-methyl morpholine; lead acetate; metal salts of strontium, cobalt and cupper. The catalyst may have a function to dissociate the block agent. An amount of the catalyst may preferably be from 0.1 to 6 parts by weight based on 100 parts of the solid content of the binder resin in the cationic electrodeposition coating composition.

Preparation and Application of Cationic Electrodeposition Coating Composition

The cationic electrodeposition coating composition of the present invention can be prepared by dispersing the binder resin emulsion, optional pigment dispersed paste and catalyst in an aqueous solvent. The binder emulsion is prepared by mixing the binder resin consisting of (a) amine-modified bisphenol epoxy resin and (b) blocked isocyanate curing agent in a liquid phase.

In one embodiment of the binder resin emulsion according to the present invention, a binder resin emulsion (A-1) contains:
a binder resin, and
(c) emulsifying resin comprising a modified epoxy resin having a quaternary ammonium group,
   wherein the binder resin comprises (a-1) amine-modified bisphenol epoxy resin having an amino group and (b) blocked isocyanate curing agent.

The binder resin emulsion (A-1) can be prepared in any conventional ways. A preferable process for preparing the binder resin emulsion (A-1) includes the steps of:
mixing (a-1) amine-modified bisphenol epoxy resin having an amino group, (b) blocked isocyanate curing agent, a part of (c) emulsifying resin, and the neutralizing acid in an aqueous solvent to emulsify the binder resin (first dilution), and
adding the remaining emulsifying resin (c) to the resulting mixture to emulsify (second dilution).

The process can provide a core-shell type binder resin emulsion whose shell part is composed of the emulsifying resin (c). The core-shell type binder resin emulsion has excellent stability even if it contains less amount of the neutralizing acid.

In one another embodiment of the binder resin emulsion according to the present invention, a binder resin emulsion (A-2) contains; a binder resin comprising:
(a-2) amine-modified bisphenol epoxy resin having an amino group and a quaternary ammonium group, and
(b) blocked isocyanate curing agent.

A process for preparing the binder resin emulsion (A-2) can include the step of mixing the amine-modified bisphenol epoxy resin (a-2) having an amino group and a quaternary ammonium group and the blocked isocyanate curing agent (b) in an aqueous solvent in any conventional ways.

Each of the binder resin emulsions (A-1) and (A-2) contains a quaternary ammonium group. Both the binder resin emulsions have improved emulsifying effect despite containing less amount of the neutralizing acid than a conventional amount, which can provide the cationic electrodeposition coating composition with lower electric conductivity and can improve throwing power or gas-pinhole property. In addition, it enables the electrocoating in lower applied voltage and can provide a thicker electrodeposition coating film.

In binder resin emulsions (A-1) and (A-2), a ratio of an equivalent number of quaternary ammonium group to an equivalent number of neutralizable amino group in the binder resin emulsion may preferably be within a range of from 1.0:1.0 to 1.0:4.0, more preferably from 1.0:2.0 to 1.0:3.5, most preferably from 1.0:2.5 to 1.0:3.0. When the equivalent number of quaternary ammonium group is over the above range, deposition of the binder resin may be deteriorated because water solubility of the binder resin is too high. When the equivalent number of quaternary ammonium group is less than the above range, adequate improvement of throwing power may not be obtained.

The binder resin emulsion (A-1) having the above range of the equivalent number can be obtained by using the amine-modified bisphenol epoxy resin (a-1) having an amino group and the emulsifying resin (c) comprising a modified epoxy resin having a quaternary ammonium group in amounts that the ratio of an equivalent number of quaternary ammonium group in (a-1) to an equivalent number of neutralizable amino group in (c) is within the above range. The binder resin emulsion (A-2) having the above range of the equivalent number can be obtained by using the amine-modified bisphenol epoxy resin (a-2) having the ratio of an equivalent number of quaternary ammonium group to an equivalent number of neutralizable amino group of within the above range. The term “neutralizable amino group” as used herein represents an amino group which is neutralized with the neutralizing acid.

The neutralizing acid can neutralize the amine-modified bisphenol epoxy resin to improve the dispersibility of the binder resin emulsion. The neutralizing acid may be contained in an aqueous solvent which is used for preparing the binder resin emulsion. Examples of the neutralizing acid include inorganic acids or organic acids, such as hydrochloric acid, nitric acid, phosphoric acid, formic acid, acetic acid, lactic acid.

Increase of a content of the neutralizing acid in the cationic electrodeposition coating composition leads an increase of neutralized rate of the amine-modified bisphenol epoxy resin and enhances water solubility of the binder resin emulsion. This also enhances dispersion stability of the binder resin emulsion. The enhanced dispersion stability of the binder resin emulsion makes deposition of the binder resin emulsion difficult, and induces decrease of the deposition of the solid content of the coating composition.

On the other hand, decrease of a content of the neutralizing acid in the cationic electrodeposition coating composition leads a decrease of neutralized rate of the amine-modified bisphenol epoxy resin and lowers water solubility of the binder resin emulsion. This also lowers the dispersion stability of the binder resin emulsion. The lowered dispersion stability of the binder resin emulsion makes deposition of the binder resin emulsion easy, and induces increase of the deposition of the solid content of the coating composition.

Accordingly, in order to improve throwing power of the cationic electrodeposition coating composition, a content of neutralizing acid therein is decreased so as to keep a neutralized rate of the amine-modified bisphenol epoxy resin in a lower level.

The amount of the neutralizing acid used for preparation of the binder resin may preferably be from 5 mg equivalent to 25 mg equivalent, based on 100 g of the solid contents of the binder resin emulsion. The lower limit of the amount of the neutralizing acid is more preferably 8 mg equivalent and the upper limit is more preferably 18 mg equivalent. The solid contents of the binder resin emulsion correspond to a total of total solid contents of (a) amine-modified bisphenol epoxy resin, (b) blocked isocyanate curing agent and (c) emulsifying resin comprising a modified epoxy resin having a quaternary ammonium group. When the amount of the neutralizing acid is smaller than 5 mg equivalent, miscibility with water of the binder resin is not sufficient and causes difficulties of the binder resin dispersing in water or great degradation of stability of the binder resin emulsion. On the other hand, when the amount of the neutralizing acid is larger than 25 mg equivalent, electric power necessary for deposition increases, and deposition ability of the solid content of the coating is degraded, which degrades the throwing power.

The term “amount of neutralizing acid” as used herein is a total amount of the neutralizing acid for neutralizing the amine-modified bisphenol epoxy resin in emulsifying, and is represented MEQ(A), which is an equivalent number (mg) based on 100 g of the solid contents of the binder resin emulsion in the coating composition.

The cationic electrodeposition coating composition according to the present invention has a quaternary ammonium group. When the cationic electrodeposition coating composition contains the binder resin emulsion (A-1), the emulsifying resin (c) comprising a modified epoxy resin having a quaternary ammonium group, which is contained in the binder resin emulsion (A-1), contains a quaternary ammonium group. When the cationic electrodeposition coating composition contains the binder resin emulsion (A-2), the amine-modified bisphenol epoxy resin (a-2) having an amino group and a quaternary ammonium group, which is contained in the binder resin emulsion (A-2), contains a quaternary ammonium group. The quaternary ammonium group in the cationic electrodeposition coating composition can improve emulsifying effect of the binder resin. Thus, the present invention provides the binder resin emulsion with excellent dispersion stability despite containing less amount of the neutralizing acid than that of a normal amount. The quaternary ammonium group in the cationic electrodeposition coating composition hardly substitutes for the neutralizing acid in the amine-modified bisphenol epoxy resin, which maintains an amino group in the epoxy resin less-neutralized condition. Therefore, the binder resin emulsion has excellent stability despite containing less amount of the neutralizing acid.

The cationic electrodeposition coating composition which contains the binder resin emulsion containing quaternary ammonium group has not been produced before the present invention. The reason why such cationic electrodeposition coating composition has not been produced is that the cationic electrodeposition coating composition containing binder resin has too high water solubility and has inferior throwing power and is not suitable for actual use when the amine-modified bisphenol epoxy resin having a quaternary ammonium group, that is obtained by modifying the epoxy resin with the tertiary amine, is used as a binder resin. In the cationic electrodeposition coating composition according to the present invention, the binder resin emulsion contains a quaternary ammonium group, and the content of quaternary ammonium group is within the range that causes no deterioration of deposition of the cationic electrodeposition coating composition and maintains prefer water solubility of the binder resin. The process for preparing the cationic electrodeposition coating composition which contains the binder resin emulsion containing a quaternary ammonium group can provide the coating composition with excellent throwing power and gas-pinhole property.

The method for preparing the binder resin emulsion containing a quaternary ammonium group within above range includes control of the solid contents of the components in the binder resin. In binder resin emulsion (A-1), a solid content ratio of the amine-modified bisphenol epoxy resin (a-1) having an amino group: the emulsifying resin comprising a modified epoxy resin (c) having a quaternary ammonium group can be controlled within the range of from 98:2 to 70:30.

It is desired for the amount of the blocked isocyanate curing agent to be sufficient to react with activated hydrogen containing functional group, such as primary amino group, secondary amino group, and hydroxyl group during curing to provide good cured coating film. The amount of the blocked isocyanate curing agent, which is represented by a solid content ratio of the amine-modified bisphenol epoxy resin to the blocked isocyanate curing agent (amine-modified bisphenol epoxy resin/curing agent), is typically within the range of preferably 90/10 to 50/50, more preferably 80/20 to 65/35.

The organic solvent is used as a solvent when synthesizing resin components, such as the amine-modified bisphenol epoxy resin, blocked isocyanate curing agent, pigment dispersing resin. A complicated procedure is necessary for completely removing the solvent. The flowability of the coating film at the time of film forming is improved by containing the organic solvent in the binder resin, and the smoothness of the coating film is improved.

Examples of the organic solvents used in the cationic electrodeposition coating composition include ethylene glycol monobutyl ether, ethylene glycol monohexyl ether, ethylene glycol monoethylhexyl ether, propylene glycol monobutyl ether, dipropylene glycol monobutyl ether, propylene glycol monophenyl ether and the like. The aqueous solvent which is used for preparing the cationic electrodeposition coating composition of the present invention may contain one or more such organic solvents.

The cationic electrodeposition coating composition may contain additives for a coating, such as a plasticizer, surfactant, antioxidant and ultraviolet absorber, in addition to the above components.

Electric conductivity of the cationic electrodeposition coating composition may preferably be 1200 to 1500 μS/cm. When the electric conductivity of the cationic electrodeposition coating composition is less than 1200 μS/cm, the improvement of throwing power may be inferior. When the electric conductivity exceeds 1500 μS/cm, the poor appearance of the coating film due to generation of gas-pinhole may be produced. The electric conductivity can be measured, for example, by using a commercially available electric conductivity tester according to JIS K 0130 (the general rule of electric conductivity test).

The cationic electrodeposition coating composition with the above range of the electric conductivity can be obtained by containing the binder resin emulsions (A-1) or (A-2) in the cationic electrodeposition coating composition, or using (d) amine-modified novolak epoxy resin for preparation of the binder resin emulsion.

The cationic electrodeposition coating composition of the present invention is electrocoated onto a substrate (an object to be coated) to form the electrodeposition coating film. The substrate can be anyone as long as it has electric conductivity, for example iron plate, steel plate, aluminum plate, surface-treated one thereof, or a molded article thereof.

Electrocoating is carried out by applying a voltage of usually 50 to 450 V between a substrate serving as cathode and an anode. When the applied voltage is lower than 50 V, the electrodeposition becomes insufficient. On the other hand, when the applied voltage is higher than 450 V, the coating film may be broken and appearance thereof becomes unusual. The electrodeposition bath temperature may generally be controlled at 10 to 45° C. during electrocoating.

The electrodeposition process comprises the steps of immersing the substrate to be coated in an electrodeposition coating composition, and applying a voltage between the substrate as cathode and an anode to cause deposition of coating film. The period of time for applying the voltage can be generally 2 to 4 minutes, though it varies with the electrodeposition condition. The term “electrodeposition coating film” as used herein refers to an uncured coating film obtained by electrocoating before it is cured by heating.

A thickness of the electrodeposition coating film may preferably be within a range of from 5 to 25 μm. When the thickness is smaller than 5 μm, rust resistance of the coating film may be not sufficiently obtained. A membrane resistance of the electrodeposition coating film in a film thickness of 20 μm may preferably be within a range of from 1000 to 1600 kΩ/cm². When the membrane resistance is smaller than 1000 kΩ/cm², rust resistance of the coating film is not sufficiently obtained and throwing power may be deteriorated. When the membrane resistance is greater than 1600 kΩ/cm², appearance of the coating film may be deteriorated. The membrane resistance of the electrodeposition coating film is more preferably within a range of from 1100 to 1500 kΩ/cm².

The membrane resistance of the electrodeposition coating film can be determined by the following mathematical formula:

$$membrane resistance ( FR ) = \frac{final applied voltage ( V )}{remaining electric current of coating ( A )}$$

After completion of the electrodeposition process, the electrodeposition coating film obtained in the manner as described above is baked at a temperature of 120 to 260° C., preferably 140 to 220° C. for 10 to 30 minutes to be cured immediately or after being washed with water, thereby the cured electrodeposition coating film is formed.

### EXAMPLES

The present invention will be further explained in detail in accordance with the following examples, however, the present invention is not limited to these examples. In the examples, “part” is based on weight unless otherwise specified.

### Production Example 1

### Production of (b) Blocked Isocyanate Curing Agent

A reaction vessel was filled with 1250 parts of diphenylmethane diisocyanate and 266.4 parts of methyl isobutyl ketone (hereafter referred to as “MIBK”) and, heated to 80° C., to which 2.5 parts of dibutyltin dilaurate was added. Then a solution obtained by dissolving 226 parts of ε-caprolactam into 944 parts of butyl cellosolve was added dropwise thereto at 80° C. for two hours. The mixture was then heated at 100° C. for four hours, and it was confirmed that an absorption based on isocyanate groups disappeared by measurement of IR spectrum. After being left to stand for cooling, 336.1 parts of MIBK was added to obtain a blocked isocyanate curing agent.

### Production Example 2

### Production of (a-1) Amine-Modified Bisphenol Epoxy Resin Having an Amino Group

A flask equipped with a stirrer, a cooling tube, a nitrogen-introducing pipe, a thermometer, and a dropping funnel was filled with 87 parts of 2,4-/2,6-tolylene diisocyanate (ratio by weight=8/2), 85 parts of MIBK, and 0.1 part of dibutyltin dilaurate. With mixing the reaction mixture, 32 parts of methanol was dropwise added. The reaction was started at room temperature, and reached to 60° C. by exothermic heat. The reaction was mainly conducted within a range of from 60 to 65° C., and was continued until absorption based on isocyanate groups disappeared by measurement of IR spectrum.

Next, 550 parts of epoxy resin having an epoxy equivalent of 188, which had been synthesized from bisphenol A and epichlorohydrin by a known method, was added to the reaction mixture, and then the temperature was raised to 125° C. Thereafter, 1.0 part of benzyldimethylamine was added to react at 130° C. until the epoxy equivalent was 330.

Subsequently, 100 parts of bisphenol A and 36 parts of octylic acid were added, and the reaction was carried out at 120° C., whereby the epoxy equivalent became 1030. Thereafter, 107 parts of MIBK was added; the reaction mixture was cooled; 79 parts of diethanolamine was added; and the reaction was carried out at 110° C. for two hours. Thereafter, the resultant was diluted with MIBK until the non-volatile content of 80%, thereby to obtain an epoxy resin (with solid resin content of 80%) having tertiary amino salt groups.

### Production Example 3

### Production of (a-2) Amine-Modified Bisphenol Epoxy Resin Having an Amino Group and a Quaternary Ammonium Group

A flask equipped with a stirrer, a cooling tube, a nitrogen-introducing pipe, a thermometer, and a dropping funnel was filled with 87 parts of 2,4-/2,6-tolylene diisocyanate (ratio by weight=8/2), 85 parts of MIBK, and 0.1 part of dibutyltin dilaurate. With mixing the reaction mixture, 32 parts of methanol was dropwise added. The reaction was started at room temperature, and heat generation raised the temperature to 60° C. The reaction was mainly conducted within a range of from 60 to 65° C., and was continued until absorption based on isocyanate groups disappeared by measurement of IR spectrum.

Next, 550 parts of epoxy resin having an epoxy equivalent of 188, which had been synthesized from bisphenol A and epichlorohydrin by a known method, was added to the reaction mixture, and then the temperature was raised to 125° C. Thereafter, 1.0 part of benzyldimethylamine was added, and the reaction was carried out at 130° C. until the epoxy equivalent was 330.

Subsequently, 100 parts of bisphenol A and 36 parts of octylic acid were added, and the reaction was carried out at 120° C., whereby the epoxy equivalent became 1030. On the other hand, 70 parts of dimethylethanolamine, 94 parts of an aqueous solution of 75% lactic acid, and 32 parts of ethylene glycol monomethyl ether were successively added into other reaction vessel and mixed at 65° C. for 30 minutes to prepare a quaternarizing agent. Thereafter, 98 parts of the resulting quaternarizing agent was added to the reaction mixture and heated at 85 to 95° C. so as to achieve acid value of 1. Next, 47 parts of diethanolamine was added to the mixture and reacted at 110° C. for 2 hours. Thereafter, the resultant was diluted with MIBK until the non-volatile content of 80%, thereby to obtain (a-2) amine-modified bisphenol epoxy resin having an amino group and a quaternary ammonium group (with solid resin content of 80%).

### Production Example 4

### Production of (d) Amine-Modified Novolak Epoxy Resin

A flask equipped with a stirrer, a cooling tube, a nitrogen-introducing pipe, and a thermometer was filled with 204 parts of MIBK, and the temperature was raised to 100° C. Into the flask, 204 parts of cresol novolak resin YD-CN 703 (manufactured by Toto Kasei Co., Ltd., epoxy equivalent: 204) was slowly added and dissolved to obtain a 50% solution of epoxy resin. Subsequently, a flask equipped with a stirrer, a cooling tube, a nitrogen-introducing pipe, a thermometer, and a dropping funnel, which was different from the aforesaid flask, was filled with 75.1 parts of N-methylethanolamine and 32.2 parts of MIBK, and the temperature was raised to 120° C. Into this, 408 parts of the 50% solution of epoxy resin obtained in the above was dropwise added for three hours. Thereafter, the temperature was maintained at 120° C. for two hours. Then, the mixture was cooled to 80° C. Further, an aqueous solution obtained by diluting 24.8 parts of 88% formic acid with 15.9 parts of ion exchange water was added and the resultant was mixed at 80° C. for 30 minutes. Subsequently, 489.4 parts of deionized water was added for dilution. Removal of MIBK under reduced pressure yielded an aqueous solution of amine-modified novolak epoxy resin having a solid content of 34%. Measurement of molecular weight by GPC on this amine-modified novolak epoxy resin showed that the number-average molecular weight was 3500.

### Production Example 5

### Production of (c) Modified Epoxy Resin Having a Quaternary Ammonium Group

First, a reaction vessel equipped with a stirring apparatus, a cooling tube, a nitrogen-introducing pipe, and a thermometer was filled with 222.0 parts of isophorone diisocyanate (hereafter referred to as IPDI) and, after dilution with 39.1 parts of MIBK, 0.2 part of dibutyltin dilaurate was added to this. Thereafter, the temperature of this mixture was raised to 50° C., and 131.5 parts of 2-ethylhexanol was dropwise added with stirring in a dried nitrogen atmosphere for two hours. By suitably cooling, the reaction temperature was maintained at 50° C. This resulted in 2-ethylhexanol half-blocked IPDI (having a solid resin content of 90.0%).

Next, 87.2 parts of dimethylethanolamine, 117.6 parts of an aqueous solution of 75% lactic acid, and 39.2 parts of ethylene glycol monobutyl ether were successively added into a suitable reaction vessel, followed by stirring at 65° C. for about half an hour to prepare a quaternarizing agent.

Next, a suitable reaction vessel was filled with 710.0 parts of EPON 829 (bisphenol A-type epoxy resin manufactured by Shell Chemical Co., Ltd., epoxy equivalent: 193 to 203) and 289.6 parts of bisphenol A, followed by heating to 150 to 160° C. under nitrogen atmosphere to start an initial exothermic reaction. The reaction mixture was allowed to react at 150 to 160° C. for about one hour and then, after the resultant was cooled to 120° C., 498.8 parts of the 2-ethylhexanol half-blocked IPDI (MIBK solution) prepared in the above was added.

The reaction mixture was maintained at 110 to 120° C. for about one hour, and then 463.4 parts of ethylene glycol monobutyl ether was added. After the mixture was cooled to 85 to 95° C. to form a uniform mixture, 196.7 parts of the quaternarizing agent prepared in the above was added. After the reaction mixture was maintained at 85 to 95° C. until the acid value became 1, 964 parts of deionized water was added to complete the quaternarization in the epoxy bisphenol A resin, thereby to yield (c) modified epoxy resin having a quaternary ammonium group (resin for dispersing pigments) having quaternary ammonium salt parts (solid resin content: 50%).

### Production Example 6

### Production of Pigment-Dispersed Paste

The modified epoxy resin having a quaternary ammonium group obtained in Production Example 5 was used as a pigment-dispersing resin. Into a sand grind mill, 120 parts of the modified epoxy resin obtained in Production Example 5, 2.0 parts of carbon black, 100.0 parts of kaolin, 80.0 parts of titanium dioxide, 18.0 parts of aluminum phosphomolybdate, and 221.7 parts of ion exchange water were filled, followed by dispersion until the particle size became equal to or less than 10 μm to yield a pigment paste (solid content: 48%).

### Example 1

### Cationic Electrodeposition Coating Composition Containing a Binder Resin Emulsion (A-1)

(a-1) amine-modified bisphenol epoxy resin having an amino group obtained in Production Example 2 (875 parts), 375 parts of the blocked isocyanate curing agent obtained in Production Example 1 were uniformly mixed in solid content ratio of 70/30. To the mixture, 2.14 parts of formic acid and 2.79 parts of acetic acid were added in such an amount that milligram equivalent value of acid based on 100 g of the binder resin emulsion solid content MEQ(A) was 8, then 98 parts of the modified epoxy resin having a quaternary ammonium group obtained in Production Example 5 was added, and ion-exchanged water was slowly added for dilution. Next, 228 parts of the modified epoxy resin having a quaternary ammonium group obtained in Production Example 5 was added and mixed. MIBK was removed under reduced pressure to obtain a binder resin emulsion (A-1) having a solid content of 36%.

To the resulting binder resin emulsion (A-1), (d) amine-modified novolak epoxy resin obtained in Production Example 4 was added in such an amount that the solid content of the amine-modified novolak epoxy resin was 1.0 parts by weight based on 100 parts by weight of the solid content of the binder resin. The pigment-dispersed paste (210 parts) obtained in Production Example 6 was added to 1110 parts of the resulting mixture, then dibutyltin oxide in solid content ratio of 1 part and ion exchange water were added to obtain a cationic electrodeposition coating composition having a solid content of 20%. Electric conductivity of the cationic electrodeposition coating composition was 1200 μS/cm. A ratio of an equivalent number of quaternary ammonium group to an equivalent number of neutralizable amino group in the binder resin emulsion was 1.0:1.0. The electric conductivity was measured at solution temperature of 25° C. by using electric conductivity tester CM-30S produced by TOA DENPA KOGYO (now DDK-TOA CORPOPATION) according to JIS K 0130 (the general rule of electric conductivity test).

### Example 2

### Cationic Electrodeposition Coating Composition Containing a Binder Resin Emulsion (A-1)

(a-1) amine-modified bisphenol epoxy resin having an amino group obtained in Production Example 2 (875 parts), 375 parts of the blocked isocyanate curing agent obtained in Production Example 1 were uniformly mixed in solid content ratio of 70/30. To the mixture, 3.80 parts of formic acid and 4.95 parts of acetic acid were added in such an amount that milligram equivalent value of acid based on 100 g of the binder resin emulsion solid content MEQ(A) was 15, then 60 parts of the modified epoxy resin having a quaternary ammonium group obtained in Production Example 5 was added, and ion-exchanged water was slowly added for dilution. Next, 140 parts of the modified epoxy resin having a quaternary ammonium group obtained in Production Example 5 was added and mixed. MIBK was removed under reduced pressure to obtain a binder resin emulsion (A-1) having a solid content of 36%.

To the resulting binder resin emulsion (A-1), (d) amine-modified novolak epoxy resin obtained in Production Example 4 was added in such an amount that the solid content of the amine-modified novolak epoxy resin was 3.2 parts by weight based on 100 parts by weight of the solid content of the binder resin. The pigment-dispersed paste (210 parts) obtained in Production Example 6 was added to 1110 parts of the resulting mixture, then dibutyltin oxide in solid content ratio of 1 part and ion exchange water were added to obtain a cationic electrodeposition coating composition having a solid content of 20%. Electric conductivity of the cationic electrodeposition coating composition was 1400 μS/cm. A ratio of an equivalent number of quaternary ammonium group to an equivalent number of neutralizable amino group in the binder resin emulsion was 1.0:2.6.

### Example 3

### Cationic Electrodeposition Coating Composition Containing a Binder Resin Emulsion (A-1)

(a-1) amine-modified bisphenol epoxy resin having an amino group obtained in Production Example 2 (875 parts), 375 parts of the blocked isocyanate curing agent obtained in Production Example 1 were uniformly mixed in solid content ratio of 70/30. To the mixture, 3.76 parts of formic acid and 4.90 parts of acetic acid were added in such an amount that milligram equivalent value of acid based on 100 g of the binder resin emulsion solid content MEQ(A) was 15, then 55 parts of the modified epoxy resin having a quaternary ammonium group obtained in Production Example 5 was added, and ion-exchanged water was slowly added for dilution. Next, 125 parts of the modified epoxy resin having a quaternary ammonium group obtained in Production Example 5 was added and mixed. MIBK was removed under reduced pressure to obtain a binder resin emulsion (A-1) having a solid content of 36%.

To the resulting binder resin emulsion (A-1), (d) amine-modified novolak epoxy resin obtained in Production Example 4 was added in such an amount that the solid content of the amine-modified novolak epoxy resin was 2.7 parts by weight based on 100 parts by weight of the solid content of the binder resin. The pigment-dispersed paste (210 parts) obtained in Production Example 6 was added to 1110 parts of the resulting mixture, then dibutyltin oxide in solid content ratio of 1 part and ion exchange water were added to obtain a cationic electrodeposition coating composition having a solid content of 20%. Electric conductivity of the cationic electrodeposition coating composition was 1400 μS/cm. A ratio of an equivalent number of quaternary ammonium group to an equivalent number of neutralizable amino group in the binder resin emulsion was 1.0:3.2.

### Example 4

### Cationic Electrodeposition Coating Composition Containing a Binder Resin Emulsion (A-2)

(a-2) amine-modified bisphenol epoxy resin having an amino group and a quaternary ammonium group obtained in Production Example 3 (875 parts), 375 parts of the blocked isocyanate curing agent obtained in Production Example 1 were uniformly mixed in solid content ratio of 70/30. To the mixture, 3.45 parts of formic acid and 4.50 parts of acetic acid were added in such an amount that milligram equivalent value of acid based on 100 g of the binder resin emulsion solid content MEQ(A) was 15, then ion-exchanged water was slowly added for dilution. MIBK was removed under reduced pressure to obtain a binder resin emulsion (A-2) having a solid content of 36%.

To the resulting binder resin emulsion (A-2), (d) amine-modified novolak epoxy resin obtained in Production Example 4 was added in such an amount that the solid content of the amine-modified novolak epoxy resin was 4.9 parts by weight based on 100 parts by weight of the solid content of the binder resin. The pigment-dispersed paste (210 parts) obtained in Production Example 6 was added to 1110 parts of the resulting mixture, then dibutyltin oxide in solid content ratio of 1 part and ion exchange water were added to obtain a cationic electrodeposition coating composition having a solid content of 20%. Electric conductivity of the cationic electrodeposition coating composition was 1500 μS/cm. A ratio of an equivalent number of quaternary ammonium group to an equivalent number of neutralizable amino group in the binder resin emulsion was 1.0:2.6.

### Comparative Example 1

Amine-modified bisphenol epoxy resin obtained in Production Example 2 (875 parts), 375 parts of the blocked isocyanate curing agent obtained in Production Example 1 were uniformly mixed in solid content ratio of 70/30. To the mixture, formic acid was added in such an amount that milligram equivalent value of acid based on 100 g of the binder resin emulsion solid content MEQ(A) was 20, then ion-exchanged water was slowly added for dilution. MIBK was removed under reduced pressure to obtain a binder resin emulsion having a solid content of 36%.

The pigment-dispersed paste (210 parts) obtained in Production Example 6 was added to 1110 parts of the resulting binder resin emulsion, then dibutyltin oxide in solid content ratio of 1 part and ion exchange water were added to obtain a cationic electrodeposition coating composition having a solid content of 20%. Electric conductivity of the cationic electrodeposition coating composition was 1600 μS/cm.

### Comparative Example 2

Amine-modified bisphenol epoxy resin obtained in Production Example 2 (875 parts), 375 parts of the blocked isocyanate curing agent obtained in Production Example 1 were uniformly mixed in solid content ratio of 70/30. To the mixture, formic acid was added in such an amount that milligram equivalent value of acid based on 100 g of the binder resin emulsion solid content MEQ(A) was 30, then ion-exchanged water was slowly added for dilution. MIBK was removed under reduced pressure to obtain a binder resin emulsion having a solid content of 36%.

The pigment-dispersed paste (210 parts) obtained in Production Example 6 was added to 1110 parts of the resulting binder resin emulsion, then dibutyltin oxide in solid content ratio of 1 part and ion exchange water were added to obtain a cationic electrodeposition coating composition having a solid content of 20%. Electric conductivity of the cationic electrodeposition coating composition was 1720 μS/cm.

The cationic electrodeposition coating compositions obtained in the above Examples and Comparative Examples were evaluated in the following way. Membrane resistance of the cationic electrodeposition coating composition

A part (10 cm) of each zinc phosphate treated steel plates (JIS G3141 SPCC-SD treated with Surfdine SD-2500 (manufactured by Nippon Paint Co., Ltd.), size: 70 mm×150 mm, thickness: 0.7 mm) was immersed in the cationic electrodeposition coating compositions obtained in the above Examples or Comparative Examples in a tank. To the steel plates, a voltage was applied and raised at 200 V over 30 seconds and the steel plates were electrocoated for 150 seconds. A membrane resistance (kΩ/cm²) was calculated by measuring a voltage in electrocoating and a residual voltage after electrbcoating in case of film thickness of 20 μm and solution temperature of 28° C.

Throwing Power

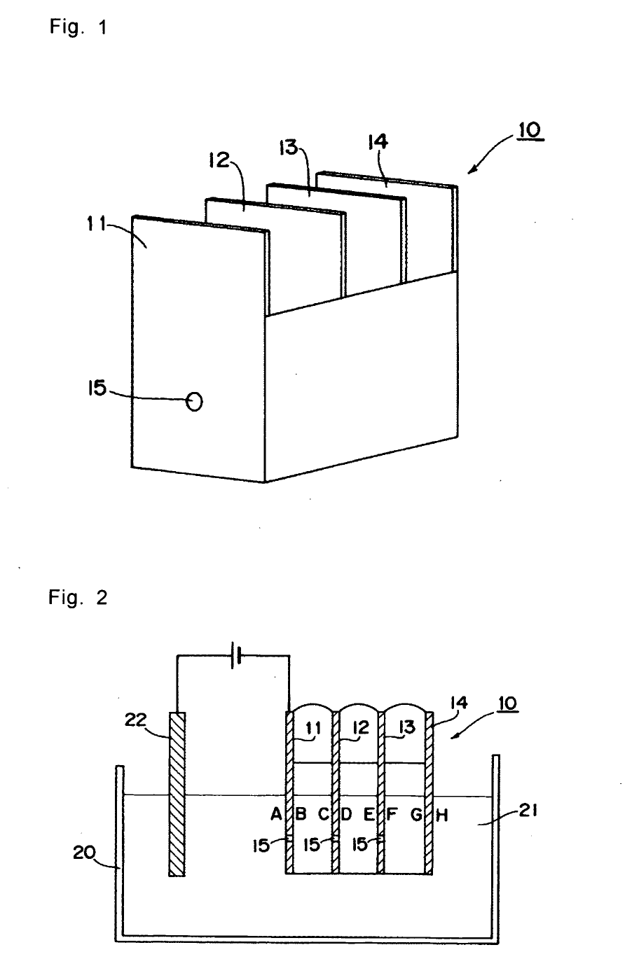

The throwing power was evaluated by so-called four-plates box method. Referring to FIG. 1, four plates 11 to 14 of zinc phosphate treated steel plates (JIS G3141 SPCC-SD treated with Surfdine SD-5000 (manufactured by Nippon Paint Co., Ltd.)) were disposed in a box 10 in parallel at an interval of 20 mm in an upright state, and the box 10 was closely sealed by an insulator such as a cloth adhesive tape at both lower parts of the two sides and a bottom surface. Through-holes 15 with 8 mmω were held at the lower part of each of steel plates 11 to 13 except steel plate 14.

A first electrodeposition bath was prepared by pouring four liters of cationic electrodeposition coating composition to a vessel made of vinyl chloride. Referring to FIG. 2, the aforesaid box 10 was immersed as an object to be coated into electrodeposition coating composition vessel 20 containing electrodeposition coating composition 21. In this case, coating composition 21 penetrated into box 10 only through each through-hole 15.

Coating composition 21 was stirred with a magnetic stirrer (not illustrated). Then, steel plates 11 to 14 were electrically connected to each other, and an opposing electrode 22 was disposed such that the distance to the nearest steel plate 11 would be 150 mm. A voltage was applied with each of the steel plates 11 to 14 serving as a cathode and the opposing electrode 22 serving as an anode, so as to perform cationic electrodeposition coating on the steel plates. The coating was carried out by raising the voltage to a voltage such that the layer thickness of the coated layer formed on the A surface of steel plate 11 would reach 15 μm in five seconds from the start of the application of the voltage, and thereafter maintaining the voltage for 175 seconds in ordinary electrodeposition or for 115 seconds in short-time electrodeposition.

Each of the steel plates that had gone through the coating process was washed with the water and baked at 170° C. for 25 minutes. After cooling it with air, film thickness was measured at the coated film formed on the A surface of the steel plate 11 which was the nearest to the opposing electrode 22 and the film thickness of the coated film formed on the G surface of the steel plate 14 which was the farthest to the opposing electrode 22, followed by evaluating the throwing power by the ratio (G/A value) of layer thickness (G surface)/layer thickness (A surface). If this value exceeds 50%, it is determined as good, whereas if this value is 50% or below, it is determined as poor. The results are shown in Tables 1 and 2.

Gas-Pinhole Property

An alloyed molten zinc plated steel plate (size: 70 mm×150 mm, thickness: 0.7 mm) subjected to chemical conversion treatment was immersed in the cationic electrodeposition coating compositions obtained in the above Examples or Comparative Examples in a tank. A voltage was applied to the steel plate and raised at 200 V over 5 seconds and the steel plates were electrocoated for 175 seconds. The resulting steel plate was washed with water and baked at 160° C. for 10 minutes to obtain a cured electrodeposition coating film. Similar coating processes except that a voltage in electrotcoating was raised 10 V each times were repeated. An appearance of the resulting cured electrodeposition coating films was observed with eyes. A voltage which generates defects in the cured electrodeposition coating film was referred to as “V₂”.

In the above throwing power examination, a voltage which produces an electrodeposition coating film with film thickness of 15 μm on A-side of the steel plate 11 within 5 seconds of applied voltage was referred to as “V₁”. ΔV was determined by the following mathematical formula:
ΔV=V₂−V₁

The higher ΔV is, the better the Gas-pinhole property of the electrodeposition coating composition is, and the more compliant to various coating conditions of the electrodeposition coating composition is. The results are shown in Tables 1 and 2.

TABLE 1

| | Example 1 | Example 2 | Example 3 | Example 4 |
|---|---|---|---|---|
| electris | 1200 | 1400 | 1400 | 1500 |
| conductivity (μS/cm) | | | | |
| ratio of equivalent | 1.0/1.0 | 1.0/2.6 | 1.0/3.2 | 1.0/2.6 |
| number of quaternary | | | | |
| ammonium group to | | | | |
| equivalent number of | | | | |
| neutralizable amino | | | | |
| group | | | | |
| solid contents of | 1.0 | 3.2 | 2.7 | 4.9 |
| anime-modified | | | | |
| novolak epoxy resin | | | | |
| membrane resistance | 1420 | 1450 | 1460 | 1320 |
| of cationic | | | | |
| electrodeposition | | | | |
| coating composition | | | | |
| (kΩ/cm²) | | | | |
| throwing power | 70 | 83 | 81 | 77 |
| gas-pinhole property | 90 | 70 | 70 | 60 |
| solid content ratio | 86/14 | 91/9 | 91/9 | — |
| of (a-1)/(c) in | | | | |
| the binder resin | | | | |
| emulsion | | | | |
| dried film thickness | 15 | 15 | 15 | 15 |
| (μm) | | | | |

TABLE 2

| | Comparative | Comparative |
|---|---|---|
| | Example 1 | Example 2 |
| electris | 1600 | 1720 |
| conductivity (μS/cm) | | |
| ratio of equivalent | — | — |
| number of quaternary | | |
| ammonium group to | | |
| equivalent number of | | |
| neutralizable amino | | |
| group | | |
| solid contents of | — | — |
| anime-modified | | |
| novolak epoxy resin | | |
| membrane resistance | 870 | 760 |
| of cationic | | |
| electrodeposition | | |
| coating composition | | |
| (kΩ/cm²) | | |
| throwing power | 34 | 42 |
| gas-pinhole property | 10 | −10 |
| solid content ratio | 100/0 | 100/0 |
| of (a-1)/(c) in | | |
| the binder resin | | |
| emulsion | | |
| dried film thickness | 15 | 15 |
| (μm) | | |

The results of Examples and Comparative Examples shows that the cationic electrodeposition coating composition of the present invention has excellent throwing power and gas-pinhole property.

The present invention provides the cationic electrodeposition coating composition which hardly generates poor appearance in coating an object and having high throwing power.

1. A cationic electrodeposition coating composition comprising a binder resin composed of an amine-modified bisphenol epoxy resin and a blocked isocyanate curing agent in emulsification state, wherein
the emulsification of the binder resin is conducted by either an amine-modified bisphenol epoxy resin having a quaternary ammonium group or an emulsifying resin having a quaternary ammonium group as an additional component other than the binder resin.

2. A cationic electrodeposition coating composition according to claim 1, which comprises a binder resin emulsion (A-1) which comprises:
a binder resin composed of (a-1) an amine-modified bisphenol epoxy resin having an amino group and (b) a blocked isocyanate curing agent, and
(c) an emulsifying resin being a modified epoxy resin having a quaternary ammonium group.

3. A cationic electrodeposition coating composition according to claim 1, which comprises a binder resin emulsion (A-2) composed of:
(a-2) an amine-modified bisphenol epoxy resin having an amino group and a quaternary ammonium group, and
(b) a blocked isocyanate curing agent.

4. The cationic electrodeposition coating composition according to claim 1, wherein a ratio of an equivalent number of quaternary ammonium group to an equivalent number of neutralizable amino group in the binder resin emulsion is within a range of from 1.0:1.0 to 1.0:4.0.

5. The cationic electrodeposition coating composition according to claim 2, wherein a solid content ratio by weight of the amine-modified bisphenol epoxy resin (a-1) to the emulsifying resin (c) in the binder resin emulsion (A-1) is within a range of from 98:2 to 70:30.

6. The cationic electrodeposition coating composition according to claim 1 further comprising (d) an anime-modified novolak epoxy resin in an amount of from 0.1 to 5.0 parts by weight based on 100 parts by weight of a solid content of the binder resin.

7. The cationic electrodeposition coating composition according to claim 1, which has an electric conductivity of from 1200 to 1500 μS/cm.

8. The cationic electrodeposition coating composition according to claim 1, wherein a coating film obtained from the cationic electrodeposition coating composition has a membrane resistance of from 1000 to 1600 kΩ/cm² at a film thickness of 20 μm.

9. A process for forming an electrodeposition coating film with prevention of generation of gas-pinhole comprising the step of immersing an object to be coated in a cationic electrodeposition coating composition to electrocoat, wherein
the cationic electrodeposition coating composition comprising a binder resin composed of an amine-modified bisphenol epoxy resin and a blocked isocyanate curing agent in emulsification state, wherein
the emulsification of the binder resin is conducted by either an amine-modified bisphenol epoxy resin having a quaternary ammonium group or an emulsifying resin having a quaternary ammonium group as an additional component other than the binder resin.

10. A process for forming an electrodeposition coating film with a film thickness of not less than 15 μm comprising the step of immersing a galvanized steel panel in a cationic electrodeposition coating composition to electrocoat, wherein
the cationic electrodeposition coating composition comprising a binder resin composed of an amine-modified bisphenol epoxy resin and a blocked isocyanate curing agent in emulsification state, wherein
the emulsification of the binder resin is conducted by either an amine-modified bisphenol epoxy resin having a quaternary ammonium group or an emulsifying resin having a quaternary ammonium group as an additional component other than the binder resin.

11. In a process for forming a coating film by cationically-electrocoating a cationic electrodeposition coating composition, a process for preventing generation of gas pinhole of the coating film characterized in that the electrodeposition coating composition comprises a binder resin emulsion having a quaternary ammonium group.
